(19) United States
(12) Patent Application Publication
(10) Pub. No.: US 2025/0326902 A1
(43) Pub. Date: Oct. 23, 2025

(54) PRINTABLE AND EXTRUDABLE ENERGY ABSORPTION MATERIALS FORMULATION AND METHOD FOR FORMING THE SAME

(71) Applicant: Nano and Advanced Materials Institute Limited, Hong Kong (CN)

(72) Inventors: Kang ZHANG, Hong kong (CN); Pak-Chung Lau, Hong Kong (CN); Christopher Cheung Yec, Hong Kong (CN); Shilong Zhang, Hong Kong (CN); Jifan Li, Hong Kong (CN)

(21) Appl. No.: 18/638,209

(22) Filed: Apr. 17, 2024

(51) Int. Cl. C08J 5/10; C08K 3/013; C08K 3/014; C08K 5/00

(52) U.S. Cl. CPC C08J 5/10; C08K 3/013; C08K 3/014; C08K 5/0016; C08J 2383/04

(57) ABSTRACT

The present invention discloses a printable and extrudable energy absorption materials formulation comprising: (a) a base composition, containing a polymer matrix, a curing agent, and a sacrificial agent; (b) a dilatancy-promoting composition, containing a dilatant material; and (c) a shear-thinning promoting composition, containing hydroxyl functionalized fillers. The present invention also discloses a method for forming the same.

### TECHNICAL FIELD

The present invention relates to the technical field of energy absorption materials, in particular to a printable and extrudable energy absorption materials formulation.

### BACKGROUND

Modern environments are extremely complex and people are prone to accidental injuries caused by falling objects, sports mishaps, and automotive accidents, which result in serious property losses and casualties. With improving awareness regarding safety among people, it has become difficult to prepare traditional protective materials comprising ceramics, alloys, and other rigid materials that take into account protection, flexibility, and comfort; thus, the research on new protective materials that are flexible and light weight has become an urgent need.

Impact-hardening material are poised to be the next generation of flexible protective materials because of their strain-rate sensitivity and excellent mechanical properties, and such materials include shear-thickening fluid (STF) and shear-stiffening gel (SSG). STF is a non-Newtonian fluid whose viscosity rises sharply with increasing shear rate or shear stress; however, its fluid nature limits applicability. Compared to STF, SSG has garnered more interest because of its better stability and lack of problems such as sedimentation and volatilization.

Shear-stiffening gel (SSG) are also referred to as shear-thickening gel, shock-hardening polymer, impact-hardening polymers, dilatant materials, and the like. The impact-hardening polymer is soft and elastic at normal conditions or at relatively low shear rates; however, when subjected to external force at a higher shear rate, polymer chains lock with each other, increasing in viscosity, and then the material will harden rapidly while absorbing and dissipating the impact energy to provide protection for users.

Clogging is an issue in printing/extruding systems, impacting their performance and efficiency. Clogging can negatively affect printing coverage, flow rate, and fiber size. The results of printing/extruding application may suffer, and in many cases, user may need to halt operations to clean or replace the mesh or nozzles.

Nozzle clogging can be caused by two main factors: particulates in the ink and the physical properties of the ink, specifically its viscosity.
1. Presence of Particulates: The primary cause of nozzle clogging is the presence of particulates in the ink which can obstruct ink flow as they accumulate within the nozzle. These particulates stem from various sources such as raw material contamination, system corrosion, inadequate filtration, or environmental debris. The size of these particulates influences the likelihood of clogging; larger particles can quickly block a nozzle or cause wear that alters the printing/extruding pattern and performance.
2. Physical property: The viscosity of the ink has a direct impact on the frequency of nozzle clogging. High-viscosity ink tends to flow slower and can create significant buildup within the nozzle's internal passages over time. This buildup can obstruct the ink and eventually lead to clogging which disrupts the printing/extruding pattern and diminishes the efficiency of the printing/extruding system.

Traditionally, the impact-hardening polymer formulation is a viscous ink exhibiting shear-thickening behavior, which is suitable for producing molded article in molding process. However, shear-thickening property is an obstacle in printing/extruding processes. When the viscous ink is subjected to shear force caused by printer head/screening printing mesh/extruding nozzle, polymer chains are entangled to dramatically increase the ink viscosity, it can harden and prevent the ink from flowing through. Accordingly, new energy absorption materials formulation is highly desirable for printing/extruding process.

### SUMMARY

The present invention provides an advanced energy absorption materials formulation that contains a high concentration of dilatant material to providing dilatancy while allowing sufficient flow to be printed/extruded from a mesh/nozzle. The advanced energy absorption materials formulation is a viscous ink that exhibits both shear thickening and shear thinning properties. The ink can be directly printed onto a substrate, specifically compression garments, to provide impact-dampening properties with high oscillation sensitivity. In addition, the ink can be compounded with a thermoplastic polymer to obtain a melt-spinnable fiber and filament.

The present invention provides screen-printing ink for compression garments. In particular, it relates to the production of thixotropic screen-printing ink containing shear thickening fluid to provide damping performance with high oscillation sensitivity. The screen-printing ink can also be foamed to obtain enhanced impact energy absorption. In addition to compression garment and fabric articles, screen printing ink can also be formulated with thermoplastic polymer to directly spin a textile filament.

In one embodiment, a printable and extrudable energy absorption materials formulation (also referred to the first ink) is provided. The formulation comprises:
(a) A base composition, containing a polymer matrix, a curing agent, and a sacrificial agent;
(b) A dilatancy-promoting composition, containing a dilatant material; and
(c) A shear-thinning promoting composition, containing hydroxyl functionalized fillers, the hydroxyl functionalized fillers are present in an amount sufficient to cause enough formation of dynamic hydrogen bonds between polymer chains and the fillers;
   wherein the formulation is a thixotropic ink, exhibiting shear thinning property during the printing/extruding process, and a printed film/extruded fiber is formed thereof; due to the extensive hydroxyl functional groups on the fillers, dynamic hydrogen bonds between polymer chains and the fillers are formed, the weak hydrogen bonds can be easily broken by shear force, resulting in the decrease in viscosity of the ink;
   wherein the thixotropic ink is configured to solidify to form cured film/fiber after curing process, the cured film/fiber exhibit dilatancy property; upon curing process, the excessive hydroxyl groups on the fillers can be reduced by reacting with the sacrificial agent through condensation reaction or ring-opening reaction.

In another embodiment, a printable and extrudable energy absorption materials formulation with more additives, also referred to the second ink, is provided. The second ink is similar to the first ink. Furthermore, the second ink can be directly printed onto a substrate, specifically compression garments, to provide impact-dampening properties with high oscillation sensitivity. In addition, the second ink can be compounded with a thermoplastic polymer to obtain a melt-spinnable fiber and filament. By further modification and stepwise optimization on the second ink formulation, the oscillation sensitivity of the cured film/fiber can be further improved, at oscillation state should be at least 2 times that at static state.

In still another embodiment, a method for forming the printable and extrudable energy absorption materials formulation (also referred to the second ink) is provided. The method comprises:
(a) preparing the base composition, by mixing the polymer matrix, the curing agent, and the sacrificial agent;
(b) preparing the dilatancy-promoting composition, by mixing the dilatant material, the plasticizer, the dispersant, and the reinforcing agent;
(c) mixing the base composition and the dilatancy-promoting composition, stirring to obtain a mixed solution;
(d) providing the shear-thinning promoting composition, containing the hydroxyl functionalized fillers; and
(e) mixing the shear-thinning promoting composition and the mixed solution, stirring to obtain the formulation.

In further another embodiment, an anti-impact cloth is provided. The anti-impact cloth comprises:
a fabric base; and
one or more anti-impact films made from the formulation of the second embodiment (also referred to the second ink) applied to at least one surface of the fabric base, with thickness no more than 3 mm, the impact resistance of the anti-impact film shall be at least level 1 according to such as ANSI 138 standard (transmitted force no more than 9 kN under impact energy of 5 J);
   wherein the oscillation sensitivity the anti-impact film at oscillation state should be at least 2 times that at static state.

The above description is only an outline of the technical schemes of the present invention. Preferred embodiments of the present invention are provided below in conjunction with the attached drawings to enable one with ordinary skill in the art to better understand said and other objectives, features and advantages of the present invention and to make the present invention accordingly.

### BRIEF DESCRIPTION OF THE DRAWINGS

The present invention can be more fully understood by reading the following detailed description of the preferred embodiments, with reference made to the accompanying drawings, wherein:

FIG. 1 Strain-dependent underlying mechanism of SSGs.

FIG. 2 Some examples of condensation reaction or ring-opening reaction.

FIG. 3 The forming mechanism of printable and extrudable energy absorption materials, from viscosity ink to cured film/fiber.

Sample picture of FIG. 4A printable energy absorption material on fabric and FIG. 4B filament made by extrudable energy absorption material.

FIG. 5 Flow curves of the second ink exhibiting shear thinning behavior by adding hydroxyl functionalized fillers.

FIG. 6 shows Loss factor (tanδ) as a function of frequency for six samples.

### DETAILED DESCRIPTION

In the application, where an element or component is said to be included in and/or selected from a list of recited elements or components, it should be understood that the element or component can be any one of the recited elements or components, or the element or component can be selected from a group consisting of two or more of the recited elements or components. Further, it should be understood that elements and/or features of a composition, an apparatus, or a method described herein can be combined in a variety of ways without departing from the spirit and scope of the present teachings, whether explicit or implicit herein.

The use of the terms “include,” “includes”, “including,” “have,” “has,” or “having” should be generally understood as open-ended and non-limiting unless specifically stated otherwise.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10% variation from the nominal value unless otherwise indicated or inferred.

It should be understood that the order of steps or order for performing certain actions is immaterial so long as the present teachings remain operable. Moreover, two or more steps or actions may be conducted simultaneously.

Unless defined otherwise, all technical and scientific terms used herein have the same meaning as commonly understood to one of ordinary skill in the art to which the presently described subject matter pertains.

Reversible Boron-Oxygen (B-O) Bonds Exist within SSG

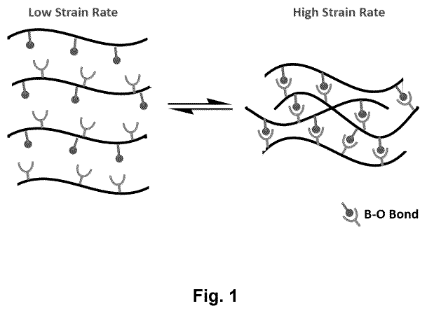

At present, the most popular shear-stiffening gel (SSG) is developed based on polydimethylsiloxane (PDMS) precursor, which is reacted with boric acid resulting in the formation of a dynamic covalent polyborosiloxane (PBS) network, crosslinked by the reversible boron-oxygen (B—O) bonds. The PDMS precursor's viscosity, the stoichiometric ratio of Boron to PDMS, the reaction time and the temperature all affect the properties of the final gel. In terms of their mechanical performance, the stiffening mechanism of PBS-based SSGs is based on the reversible breaking and reformation of the B—O bonds, as illustrated in FIG. 1.

Reversible boron-oxygen (B—O) bonds exist within SSG. When a low strain rate load is applied, the B—O bond breaks slowly and molecular chains have enough time to untwist, thereby showing macroscopic plasticity. When a high strain rate load is applied, the B—O bonds do not break in time and the molecular chains become entangled, which causes reversible a transition from a viscous to rubbery state and dissipates significant energy in the process. Surprisingly, this rheological property is not affected after the destruction caused by a high-velocity impact and has been widely used in damping materials, impact protection, cushioning, vibration control and other fields.

In a first embodiment, the present invention discloses a printable and extrudable energy absorption materials formulation (also referred to the first ink) comprising:
(a) A base composition, containing a polymer matrix, a curing agent, and a sacrificial agent;
(b) A dilatancy-promoting composition, containing a dilatant material; and
(c) A shear-thinning promoting composition, containing hydroxyl functionalized fillers, the hydroxyl functionalized fillers are present in an amount sufficient to cause enough formation of dynamic hydrogen bonds between polymer chains and the fillers;
   wherein the formulation is a thixotropic ink, exhibiting shear thinning property during the printing/extruding process, and a printed film/extruded fiber is formed thereof; due to the extensive hydroxyl functional groups on the fillers, dynamic hydrogen bonds between polymer chains and the fillers are formed, the weak hydrogen bonds can be easily broken by shear force, resulting in the decrease in viscosity of the ink;
   wherein the thixotropic ink is configured to solidify to form cured film/fiber after curing process, the cured film/fiber exhibit dilatancy property; upon curing process, the excessive hydroxyl groups on the fillers can be reduced by reacting with the sacrificial agent through condensation reaction or ring-opening reaction.

As bond energy of B—O bond is 536 KJ/mol while bond energy of hydrogen bond is 6-30 KJ/mol. Therefore, the breaking of hydrogen bond (shear thinning effect) is more susceptible to be triggered over B—O bond (shear thickening effect) during the printing process.

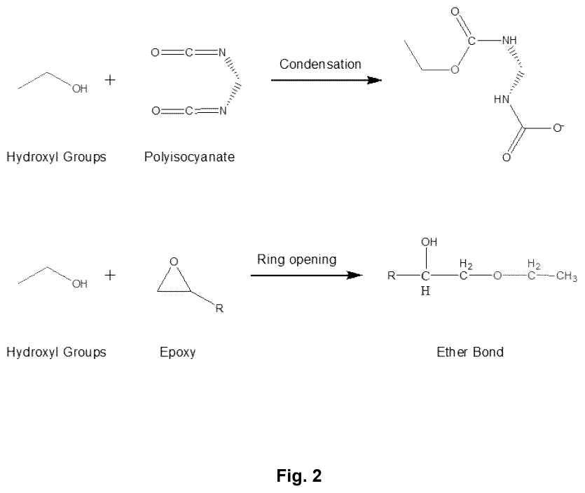

Upon curing process, by the incorporation of curing agent and sacrificial agent, the excessive hydroxyl groups on the fillers responsible for the shear thinning property can be reduced by reacting with the sacrificial agent through condensation reaction or ring-opening reaction, some examples are illustrated in FIG. 2. By the elimination of hydrogen bonds in the polymer matrix system, the shear thickening behavior of the cured dilatant material can be recovered and the resulting cured film/fiber exhibits damping performance with high oscillation sensitivity.

Upon curing process, the shear thickening effect of the dilatant material is provided by the strong dynamic boron-oxygen bond (B—O bond) interconnected between polymer chains. Under high oscillation, the reversible bond breaking and reforming in the polymer network resist the movement of polymer chains, enhancing the tensile strength of the dilatant material. Under low strain rate, the loosely linked bonds between polymer chains in the network can move easily, resulting in lower strength.

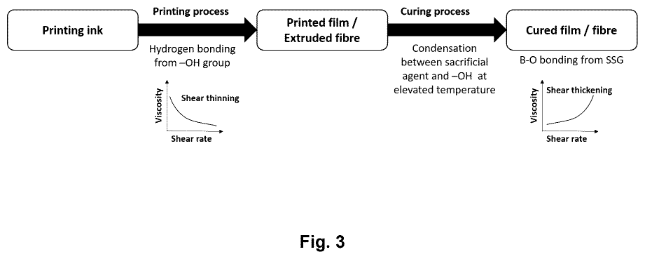

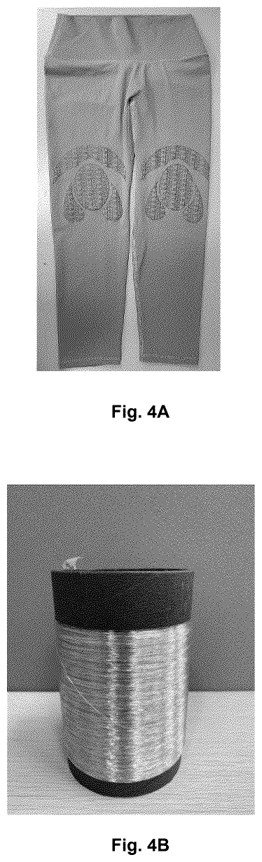

FIG. 3 shows the forming mechanism of printable and extrudable energy absorption materials, from viscous ink to cured film/fiber.

In this embodiment, the hydroxyl functionalized fillers are provided at a concentration of at least 2 parts per hundred weight of the polymer matrix, so as to cause enough formation of dynamic hydrogen bonds between polymer chains and the fillers. The hydroxyl functionalized fillers comprise hydroxyl functionalized silica, clay, carbon nanotube, hydroxylated carbon nanotube, or mixtures thereof.

Additionally, the hydroxyl functionalized fillers function as shear thinning agent in the first ink during printing or extruding process, and function as reinforcement to enhance the strength and modulus of the cured film/fiber after curing process.

The sacrificial agent are provided at a concentration of at least 2 parts per hundred weight of the polymer matrix. The sacrificial agent comprises polyisocyanate, such as methylene diphenyl diisocyanate (MDI) and toluene diisocyanate (TDI), or epoxy-containing polymer.

The polymer matrix comprises ethylene vinyl acetate copolymer, ethylene-propylene diene rubber, polyurethane, silicone rubber, styrene-butadiene rubber, acrylonitrile-butadiene rubber, natural rubber, polychloroprene rubber, or combinations thereof.

In this embodiment, the dilatant material is provided at a concentration of between 5 and 50 parts per hundred weight of the polymer matrix, so as to cause dilatancy property to the cured film/fiber. Additionally, the dilatant material comprises siloxane polymer, a hydroxyl-terminated dialkylsiloxane polymer, a borate crosslinked hydroxyl-terminated dialkylsiloxane polymer, a siloxane polymer comprising a borated polydimethylsiloxane, a Polyborodimethylsiloxane (PBDMS), a metal oxide/polyethylene glycol dispersion, a metal oxide/poly (ethylene oxide), or a combination thereof.

### Polymer Damping Material and Application in Compression Garments

Polymer damping material is a kind of functional material which can convert mechanical vibration into heat dissipation. This kind of material can be used to reduce the vibration and noise of all kinds of machinery, and to improve the precision and life of machinery. It has been widely used in the fields of transportation, municipal engineering, high-rise buildings, precision instruments, aerospace, military equipment and so on. In fact, the effective high damping materials require a damping coefficient of tanδ>0.3 at a wide temperature range. However, the effective damping temperature of a general viscoelastic material is mostly near the glass transition temperature (Tg) and the temperature range is narrow. With the increase of temperature, the resonance intensity increases, and its damping coefficient (tanδ) is significantly reduced, which makes it impossible to adapt some special working conditions, such as extreme conditions of high and low temperature alternating.

Due to the typical semi-organic and semi-inorganic structure, silicone rubber has both the thermal stability of inorganic polymer, and the flexibility of organic polymer. Therefore, silicone rubber has excellent low temperature resistance and resistance to high temperature performance. The glass transition temperature of silicone rubber is relatively low (−70˜−110° C.), and the structure of Si—O—Si bond makes its mechanical properties keeping stable in a wide temperature range (−50˜200° C.). The damping property of silicone rubber is mainly due to the dynamic deformation under the action of dynamic stress. The external force response of rubber is divided into the elastic part and the viscous part, and the strain will fall behind the stress. Importantly, the mutual friction between the molecules occurs when the rubber exhibits a cyclical change of stretching and retraction. Moreover, the mechanical energy is dissipated by the running of thermal energy, thereby achieving the effect of vibration and noise reduction. However, the damping properties of silicone rubber are lower at room temperature, generally near the Tg (−129˜−70° C.), and the tanδ of the material is generally below 0.1. It is necessary to modify the damping property to meet the requirements.

Polyborosiloxanes (PBS), which was invented initially in the search for substitutes of natural rubbers, possess reversible physical cross-links. A material like PBS may be denoted a supramolecular elastomer. At room temperature, pure PBSs behave elastically under a rapid strain variation, and suffer from brittle fractures. However, on longer time-scales, they flow as a viscous fluid. The fascinating viscoelastic properties made PBSs applicable in education on various deformation processes. The molecular structure of the PBS-gel is similar to silicone rubber, and the shear hardening gel itself has a strong energy dissipation effect.

Compression garments (CG) have been widely used in medicine in patients with venous disease, restricted mobility or with an immobilization of the lower limb for many years. CG create an external pressure gradient on the body surface which improves venous hemodynamics and prevents leg swelling and blood clots. The wearing of CG in sport has also become very popular during and after training or competition in order to improve physical performances and to accelerate recovery. Suggested mechanisms include attenuation of muscle oscillation during exercise, enhanced venous return, blood flow and muscle oxygenation with accelerated metabolic removal, reduced post-exercise edema and attenuated markers of muscle damage. CG could have a beneficial influence on endurance exercise mainly by attenuating perceived exertion and muscle soreness and by improving running economy. CG could also affect neuromuscular performances such as vertical jumping and sprint performance. The exact mechanisms by which CG impact neuromuscular performances are not clear, but it may be due to the activation of cutaneous mechanoreceptors which elicits enhancements in the ability to perceive position in space and improves accuracy of motor actions such as jumping technique. The additional sensory cues from cutaneous mechanoreceptors provided by CG are also likely to improve movement control such as balance control.

Usually, compression garments (CG) are made by forming a shock absorbing material on fibre/fabric. Due to the shear thickening mechanism of shock absorbing material, in relaxed state with low muscle vibration, the coated fibre/fabric remains flexible and easy to stretch to ensure comfort. During physical activity with high muscle oscillation, the polymer network resists the movement of polymer chains and dissipate the elastic energy. The coated fibre/fabric becomes stiff with enhanced tensile strength at least 2 times higher than that at static state, providing sufficient support to muscle with reduced movement. In other words, the oscillation sensitivity of the shock absorbing material on fibre/fabric at oscillation state should be at least 2 times that at static state.

For usual rest state, the anti-impact film (shock absorbing material) on cloth must be light and soft to ensure the comfort and convenience of wearing and operation. Therefore, the film thickness shall no bigger than 3 mm and the density shall no bigger than 0.6 g/cm³. Yet upon the impact, the film shall provide efficient protection to prevent the occurring of injury. Furthermore, the impact resistance of the film shall be at least level 1 according to such as ANSI 138 standard (transmitted force no more than 9 kN under impact energy of 5 J).

In a second embodiment of this invention, we provided a printable and extrudable energy absorption materials formulation with more additives, also referred to the second ink, similar to the first ink in the first embodiment. The second ink can be directly printed onto a substrate, specifically compression garments, to provide impact-dampening properties with high oscillation sensitivity. In addition, the second ink can be compounded with a thermoplastic polymer to obtain a melt-spinnable fiber and filament or directly extruded into a fiber and filament. By further modification and stepwise optimization on the second ink formulation, the oscillation sensitivity of the cured film/fiber can be further improved, at oscillation state should be at least 2 times that at static state.

In this embodiment, the second ink comprises: (a) the base composition, containing polymer matrix, curing agent, and sacrificial agent. The base composition optionally contains expandable microsphere for preparing foamed energy absorption materials to obtain enhanced impact energy absorption; (b) the dilatancy-promoting composition, containing the dilatant material, and a reinforcing agent; and (c) the shear-thinning promoting composition, containing hydroxyl functionalized fillers. The second ink optionally contains antioxidant and/or anti-UV agent.

The dilatancy-promoting composition further contains a plasticizer, provided at a concentration of between 0.1 and 2 parts per hundred weight of the polymer matrix. Plasticizer acts as a softening agent by embedding with the polymer chains of dilatant material. These interactions reduce the intermolecular forces between polymer chains, increasing chain mobility and softening the polymer matrix, especially when the polymer was strained at low rate or frequency. With the existence of plasticizer, the stress of composites was significantly decreased at low frequency strain, yet slightly or none decreased at high frequency strain. Thus, the rate sensitivity is significantly improved. The higher the amount of plasticizer present in dilatant material, the higher the oscillation sensitivity and energy dissipation of the material. In a preferred case, the plasticizer comprises fatty acid, oleic acid, glycerin or glyceryl trioleate.

However, the plasticizer may result into the excessive fluency of the dilatant material. Therefore, the hydroxyl functionalized fillers and other additives could be easy to settle.

The dilatancy-promoting composition further contains a dispersant, provided at a concentration of between 0.5 and 10 parts per hundred weight of the polymer matrix. The dispersant molecules are oriented with dilatant material to form network structure by intermolecular forces, such as hydrogen bonding and van der Waals forces. The extra intermolecular forces provided enhances the overall strength of the dilatant material, playing an important role in expressing shear thickening effect of the dilatant material in polymer matrix. Meanwhile, the network structure of dispersant provides resistance of other ingredient to flow, preventing the ingredients from settling to the bottom. This helps to maintain the homogeneity and stability throughout its shelf life. In a preferred case, the dispersant comprises castor oil derivatives or diamide waxes.

The dilatancy-promoting composition further contains a reinforcing agent, provided at a concentration of between 1.2 and 8 parts per hundred weight of the polymer matrix. Reinforcing agent contains finely divided particles with high surface area and surface functional groups. The uniform dispersion and aggregation of reinforcing agent within the dilatant material matrix leads to the formation of three-dimensional network structure by hydrogen bonding. The higher the stress of the dilatant material, the higher the oscillation sensitivity to be contributed in the energy absorption polymer matrix ink. In preferred case, the reinforcing agent comprises hydrophobic fumed silica, calcium carbonate or CNT.

According to the second embodiment, the present invention discloses a method for forming the printable and extrudable energy absorption materials formulation (also referred to the second ink), comprising:
(a) preparing the base composition, by mixing the polymer matrix, the curing agent, and the sacrificial agent;
(b) preparing the dilatancy-promoting composition, by mixing the dilatant material, the plasticizer, the dispersant, and the reinforcing agent;
(c) mixing the base composition and the dilatancy-promoting composition, stirring to obtain a mixed solution;
(d) providing the shear-thinning promoting composition, containing the hydroxyl functionalized fillers; and
(e) mixing the shear-thinning promoting composition and the mixed solution, stirring to obtain the formulation

According to the second embodiment, the present invention discloses an anti-impact cloth comprises:
a fabric base; and
one or more anti-impact films made from the formulation of the second embodiment (also referred to the second ink) applied to at least one surface of the fabric base, with thickness no more than 3 mm, the impact resistance of the anti-impact film shall be at least level 1 according to such as ANSI 138 standard (transmitted force no more than 9 kN under impact energy of 5 J);
   wherein the oscillation sensitivity the anti-impact film at oscillation state should be at least 2 times that at static state.

Moreover, the density of the anti-impact film is less than 0.6 g/cm³ while the formulation contains expandable microspheres in sufficient amount.

FIG. 4A shows printable energy absorption material on fabric, and FIG. 4B shows filament made by extrudable energy absorption material.

In a third embodiment of this invention, we provide a preferred formulation. The printable and extrudable energy absorption materials formulation comprises: (a) 100 parts of silicone rubber; (b) 35-45 parts per hundred rubber of PBDMS; (c) 2-10 parts per hundred rubber of hydroxyl functionalized filler; (d) 0.5-5 parts per hundred rubber of curing agent; (e) 2-5 parts per hundred rubber of sacrificial agent; (f) 0.2-1 parts per hundred rubber of a plasticizer; (g) 0.8-8 parts per hundred rubber of a dispersant; and (h) 1.2-8 parts per hundred rubber of reinforcing agent.

The following examples are provided to illustrate further and to facilitate the understanding of the present teachings and are not in any way intended to limit the invention.

### EXAMPLES

### Example 1—the Effect of Dilatant Material on Oscillation Sensitivity

The coated damping fabric (also referred to the sample) is prepared by screen print a thin film of the second ink on an elastic fabric and cure. Table 1 shows the oscillation sensitivity of pure fabric and fabric coated with 40 phr dilatant material and 4 phr hydroxyl functionalized filler. For the fabric coated with dilatant material and hydroxyl functionalized filler, it is cured by the curing agent with the addition of sacrificial agent. The oscillation sensitivity of the fabric are calculated by dividing the dynamic strength at 60% stretching at 15 Hz oscillation from dynamic mechanical analysis (DMA) by the static strength at 60% stretching from MTS tensile tester under stretching rate of 50 mm/min.

The oscillation sensitivity of pure fabric is 1.40. With the incorporation of 40 phr dilatant material and 4 phr hydroxyl functionalized filler, the oscillation sensitivity of the sample enhances to 2.26. It is evident that the sample with dilatant material exhibits greater oscillation sensitivity to stretching. It is noted that if the formulation is without hydroxyl functionalized filler particle, the viscosity of dilatant material/silicone is high. This leads to the exceptionally high viscosity of the ink which is difficult to print. Therefore, there is no oscillation sensitivity data for the composite of silicone rubber and dilatant material. By further modification and stepwise optimization on the second ink formulation, the oscillation sensitivity and the printing process can be further improved as expressed in the following examples.

TABLE 1

| | | | | Static | Dynamic | |
|---|---|---|---|---|---|---|
| | Silicone | Dilatant | Filler | Strength | Strength | |
| | rubber | material | particle | at 60% | at 60% at | Oscillation |
| Sample | (phr) | (phr) | (phr) | (MPa) | 15 Hz (MPa) | Sensitivity |
| Pure | 0 | 0 | 0 | 0.23 | 0.33 | 1.40 |
| fabric | | | | | | |
| 40 phr | 100 | 40 | 4 | 0.19 | 0.43 | 2.26 |
| dilatant | | | | | | |

### Example 2—the Effect of Plasticizer on Oscillation Sensitivity

Plasticizer acts as a softening agent by embedding with the polymer chains of dilatant material. These interactions reduce the intermolecular forces between polymer chains, increasing chain mobility and softening the polymer matrix, especially when the polymer is strained at low rate or frequency. With the existence of plasticizer, the stress of dilatant material is significantly decreased at low frequency strain, yet slightly or none decreased at high frequency strain. Thus, the rate sensitivity of the dilatant material is significantly improved. The higher the amount of plasticizer present in dilatant material, the higher the oscillation sensitivity and energy dissipation of the material.

As shown in the Table 2, the comparison of fabric coated with energy absorption film after cured by curing agent with the addition of sacrificial agent are listed. The incorporation of 0.356 phr plasticizer in the dilatant significantly increases the oscillation sensitivity of the sample from 2.26 to 2.83. However, as further increase in plasticizer slightly reduces the stress of the dilatant material, the contribution of the dilatant material to the overall polymer composite decreases and thereby slightly reduces the oscillation sensitivity of the polymer composite. Therefore, further increase in the plasticizer up to 1.050 phr reduces the oscillation sensitivity to 2.62.

TABLE 2

| | | | | | Static | Dynamic | |
|---|---|---|---|---|---|---|---|
| | Silicone | Dilatant | | Filler | Strength | Strength | |
| | rubber | material | Plasticizer | particle | at 60% | at 60% at | Oscillation |
| Sample | (phr) | (phr) | (phr) | (phr) | (MPa) | 15 Hz (MPa) | Sensitivity |
| 0 phr | 100 | 40 | 0 | 4 | 0.19 | 0.43 | 2.26 |
| Plasticizer | | | | | | | |
| 0.356 phr | 100 | 39.644 | 0.356 | 4 | 0.26 | 0.74 | 2.83 |
| Plasticizer | | | | | | | |
| 0.706 phr | 100 | 39.294 | 0.706 | 4 | 0.24 | 0.64 | 2.67 |
| Plasticizer | | | | | | | |
| 1.050 phr | 100 | 38.950 | 1.050 | 4 | 0.23 | 0.61 | 2.62 |
| Plasticizer | | | | | | | |

### Example 3—the Effect of Dispersant on Oscillation Sensitivity

Dispersant is a rheological additive that provides viscosity and stress to the dilatant material. Hence, proper specifies and dosage of dispersant was introduced into the system to improve the viscosity of the dilatant at resting state, maintaining the homogeneity and stability of the dilatant material during long time of storage.

As shown in the Table 3, the comparison of fabric coated with energy absorption film after cured by curing agent with the addition of sacrificial agent are listed. the addition of 1.210 phr dispersant significantly increases the oscillation sensitivity of the sample from 2.83 to 3.27. Further increase in the dispersant to 2.348 phr enhances the oscillation sensitivity to the maximum of 3.68. It slightly reduces to 3.51 when 6.050 phr dispersant is added as the stress of the dilatant material is too high that restricts its elasticity and thereby the oscillation sensitivity.

TABLE 3

| | | | | | | Static | Dynamic | |
|---|---|---|---|---|---|---|---|---|
| | Silicone | Dilatant | | | Filler | Strength | Strength | |
| | rubber | material | Plasticizer | dispersant | particle | at 60% | at 60% at | Oscillation |
| Sample | (phr) | (phr) | (phr) | (phr) | (phr) | (MPa) | 15 Hz (MPa) | Sensitivity |
| 0 phr | 100 | 39.644 | 0.356 | 0 | 4 | 0.26 | 0.74 | 2.83 |
| dispersant | | | | | | | | |
| 1.210 phr | 100 | 38.444 | 0.356 | 1.210 | 4 | 0.35 | 1.14 | 3.27 |
| dispersant | | | | | | | | |
| 2.348 pht | 100 | 37.316 | 0.356 | 2.348 | 4 | 0.25 | 0.92 | 3.68 |
| dispersant | | | | | | | | |
| 6.050 phr | 100 | 33.648 | 0.356 | 6.050 | 4 | 0.31 | 1.09 | 3.51 |
| dispersant | | | | | | | | |

### Example 4—the Effect of Reinforcing Agent on Oscillation Sensitivity

Reinforcing agent, such as hydrophobic fumed silica, calcium carbonate, CNT, etc., are finely divided particles with high surface area and surface functional groups. It allows uniform dispersion and aggregation within the dilatant material matrix effectively reinforces the stress of the dilatant material. The higher the stress of the dilatant material, the higher the oscillation sensitivity to be contributed in the energy absorption polymer matrix ink.

As displayed in Table 4, the comparison of fabric coated with energy absorption film after cured by curing agent with the addition of sacrificial agent are listed. The addition of reinforcing agent in the dilatant material from 1.610 phr to 6.933 phr enhances the oscillation sensitivity of the sample from 3.69 to 3.79. It is evident that upon stepwise modification on the formulation of the printable energy absorption ink, the oscillation sensitivity of the damping fabric is significantly improved from 2.26 to 3.79.

TABLE 4

| | | | | | | | | Dynamic | |
|---|---|---|---|---|---|---|---|---|---|
| | | | | | | | Static | Strength | |
| | Silicone | Dilatant | | | Reinforcing | Filler | Strength | at 60% | |
| | rubber | material | Plasticizer | dispersant | agent | particle | at 60% | at 15 Hz | Oscillation |
| Sample | (phr) | (phr) | (phr) | (phr) | (phr) | (phr) | (MPa) | (MPa) | Sensitivity |
| 0 phr | 100 | 37.316 | 0.356 | 2.348 | 0 | 4 | 0.25 | 0.92 | 3.68 |
| reinforcing | | | | | | | | | |
| agent | | | | | | | | | |
| 1.610 phr | 100 | 35.815 | 0.356 | 2.348 | 1.610 | 4 | 0.29 | 1.06 | 3.69 |
| reinforcing | | | | | | | | | |
| agent | | | | | | | | | |
| 4.470 phr | 100 | 33.147 | 0.356 | 2.348 | 4.470 | 4 | 0.24 | 0.90 | 3.72 |
| reinforcing | | | | | | | | | |
| agent | | | | | | | | | |
| 6.933 phr | 100 | 30.849 | 0.356 | 2.348 | 6.933 | 4 | 0.32 | 1.23 | 3.79 |
| reinforcing | | | | | | | | | |
| agent | | | | | | | | | |

### Example 5—the Effect of Filler Particle on Oscillation Sensitivity

The filler particle, such as hydrophilic silica, clay, CNT, etc., with well-designed fraction ratio and particle size ratio, can function as shear thinning agent in the second ink and matrix that can effectively reduce stress and viscosity during the printing or fiber extruding process. The filler particles in the second ink interact with each other in the polymer matrix by attractive forces with a network structure. Under shear stress during printing or extruding, the interactions in the polymer matrix weaken and decrease in viscosity that allow the material to flow more readily with shear thinning behavior. This improves the workability and moldability of the material, enabling it to fill intricate molds or conform to complex shapes with greater ease.

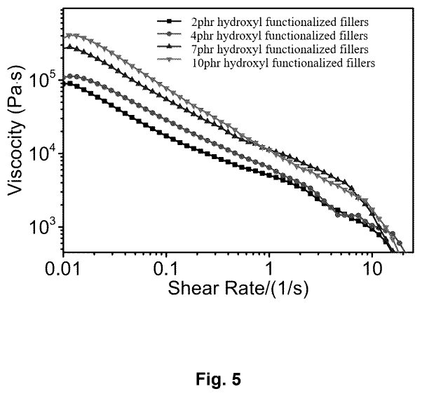

Please refer to FIG. 5, the addition of filler particle from 2 phr to 10 phr enhances the shear thinning behavior of the second ink that improves the workability and ensures the second ink is easily printable during the screen printing and fibre extruding processes. As shown in the Table 5, there is no obvious difference in the oscillation sensitivity of the fabric upon addition of more filler particle from 2 phr to 10 phr ranging from 3.71 to 3.79. The oscillation sensitivity at the higher dosage of filler particle, particularly 7 phr and 10 phr, is slightly reduced as the stress of the ink is enhanced to an extent that may restrict the elasticity and thereby oscillation sensitivity of the polymer matrix.

TABLE 5

| | | | | | | | | Dynamic | |
|---|---|---|---|---|---|---|---|---|---|
| | | | | | | | Static | Strength | |
| | Silicone | Dilatant | | | Reinforcing | Filler | Strength | at 60% | |
| | rubber | material | Plasticizer | dispersant | agent | particle | at 60% | at 15 Hz | Oscillation |
| Sample | (phr) | (phr) | (phr) | (phr) | (phr) | (phr) | (MPa) | (MPa) | Sensitivity |
| 2 phr | 100 | 30.849 | 0.356 | 2.348 | 6.933 | 2 | 0.275 | 1.04 | 3.78 |
| filler | | | | | | | | | |
| 4 phr | 100 | 30.849 | 0.356 | 2.348 | 6.933 | 4 | 0.324 | 1.23 | 3.79 |
| filler | | | | | | | | | |
| 7 phr | 100 | 30.849 | 0.356 | 2.348 | 6.933 | 7 | 0.276 | 1.04 | 3.75 |
| filler | | | | | | | | | |
| 10 phr | 100 | 30.849 | 0.356 | 2.348 | 6.933 | 10 | 0.359 | 1.33 | 3.71 |
| filler | | | | | | | | | |

### Example 6

The Examples of Filament Performance Made by the Viscous Ink (the Second Ink)

The second ink can be mixed with thermoplastic materials such as TPU to spin into filament. Also different fillers can be added into the composite to fine tune the diameter and tensile strength of filament. The fiber diameter, tensile strength and elongation of filaments with different formulation are listed in Table 6. For S1-S8, the oscillation sensitivity are in the range of 2.0 to 4.7.

TABLE 6

| | | Fiber | Static Tensile | |
|---|---|---|---|---|
| | | diameter | Strength at | Elongation |
| Code | Sample | (micron) | Break (MPa) | at Break (%) |
| S1 | Polyether TPU + 5% | 310 | 89 | 330 |
| | Viscous Ink (A1) | | | |
| S2 | A1 + 5% MB50017 | 480 | 17 | 600 |
| S3 | A1 + 10% DEHP | 250 | 23 | 370 |
| S4 | A1 + 10% DOTP | 150 | 28 | 358 |
| S5 | A1 + 5% Glass Fiber | 200 | 84 | 309 |
| | Powder | | | |
| S6 | A1 + 10% Glass Fiber | 200 | 67 | 376 |
| | Powder | | | |
| S7 | A1 + 20% Glass Fiber | 200 | 54 | 287 |
| | Powder | | | |
| S8 | A1 + 2% DOTP + 3% | 200 | 34 | 260 |
| | MB50017 + 0.5% | | | |
| | Magnesium Stearate | | | |

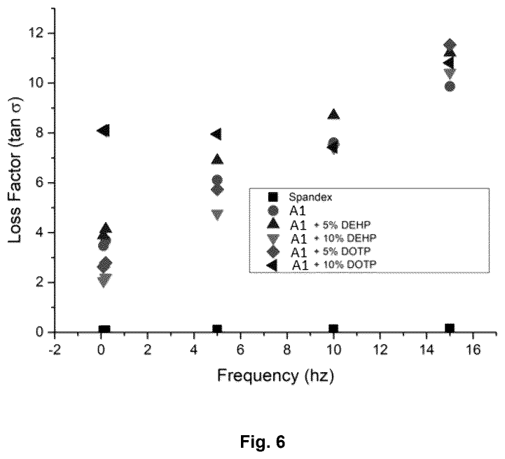

The loss factor of the filament with different formulation are also tested as shown in FIG. 6. All the filaments show good damping performance.

The above embodiments are only used to illustrate the principles of the present invention, and they should not be construed as to limit the present invention in any way. The above embodiments can be modified by those with ordinary skill in the art without departing from the scope of the present invention as defined in the following appended claims.

What is claimed is:

1. A printable and extrudable energy absorption materials formulation comprising:
(a) A base composition, containing a polymer matrix, a curing agent, and a sacrificial agent;
(b) A dilatancy-promoting composition, containing a dilatant material; and
(c) A shear-thinning promoting composition, containing hydroxyl functionalized fillers, the hydroxyl functionalized fillers are present in an amount sufficient to cause enough formation of dynamic hydrogen bonds between polymer chains and the fillers;
wherein the formulation is a thixotropic ink, exhibiting shear thinning property during the printing/extruding process, and a printed film/extruded fiber is formed thereof; due to the extensive hydroxyl functional groups on the fillers, dynamic hydrogen bonds between polymer chains and the fillers are formed, the weak hydrogen bonds can be easily broken by shear force, resulting in the decrease in viscosity of the ink;
wherein the thixotropic ink is configured to solidify to form cured film/fiber after curing process, the cured film/fiber exhibit dilatancy property; upon curing process, the excessive hydroxyl groups on the fillers can be reduced by reacting with the sacrificial agent through condensation reaction or ring-opening reaction.

2. The formulation of claim 1, wherein the hydroxyl functionalized fillers are provided at a concentration of at least 2 parts per hundred weight of the polymer matrix, so as to cause enough formation of dynamic hydrogen bonds between polymer chains and the fillers.

3. The formulation of claim 1, wherein the hydroxyl functionalized fillers comprise hydroxyl functionalized silica, clay, carbon nanotube, hydroxylated carbon nanotube, or mixtures thereof.

4. The formulation of claim 1, wherein the sacrificial agent is provided at a concentration of at least 2 parts per hundred weight of the polymer matrix.

5. The formulation of claim 1, wherein the sacrificial agent comprises polyisocyanate or epoxy-containing polymer.

6. The formulation of claim 1, wherein the polymer matrix comprises ethylene vinyl acetate copolymer, ethylene-propylene diene rubber, polyurethane, silicone rubber, styrene-butadiene rubber, acrylonitrile-butadiene rubber, natural rubber, polychloroprene rubber, or combinations thereof.

7. The formulation of claim 1, wherein the dilatant material is provided at a concentration of between 5 and 50 parts per hundred weight of the polymer matrix, so as to cause dilatancy property to the cured film/fiber.

8. The formulation of claim 1, wherein the dilatant material comprises siloxane polymer, a hydroxyl-terminated dialkylsiloxane polymer, a borate crosslinked hydroxyl-terminated dialkylsiloxane polymer, a siloxane polymer comprising a borated polydimethylsiloxane, a Polyborodimethylsiloxane (PBDMS), a metal oxide/polyethylene glycol dispersion, a metal oxide/poly (ethylene oxide), or a combination thereof.

9. The formulation of claim 1, wherein the dilatancy-promoting composition contains a plasticizer, provided at a concentration of between 0.1 and 2 parts per hundred weight of the polymer matrix.

10. The formulation of claim 9, wherein the plasticizer comprises fatty acid, oleic acid, glycerin or glyceryl trioleate.

11. The formulation of claim 9, wherein the dilatancy-promoting composition contains a dispersant, provided at a concentration of between 0.5 and 10 parts per hundred weight of the polymer matrix.

12. The formulation of claim 11, wherein the dispersant comprises castor oil derivatives or diamide waxes.

13. The formulation of claim 11, wherein the dilatancy-promoting composition contains a reinforcing agent, provided at a concentration of between 1.2 and 8 parts per hundred weight of the polymer matrix.

14. A method for forming the printable and extrudable energy absorption materials formulation of claim 13, comprising:
(a) preparing the base composition, by mixing the polymer matrix, the curing agent, and the sacrificial agent;
(b) preparing the dilatancy-promoting composition, by mixing the dilatant material, the plasticizer, the dispersant, and the reinforcing agent;
(c) mixing the base composition and the dilatancy-promoting composition, stirring to obtain a mixed solution;
(c) providing the shear-thinning promoting composition, containing the hydroxyl functionalized fillers; and
(e) mixing the shear-thinning promoting composition and the mixed solution, stirring to obtain the formulation.

15. The formulation of claim 1, wherein the base composition contains expandable microsphere.

16. The formulation of claim 1, wherein the formulation contains antioxidant and/or anti-UV agent.

17. The formulation of claim 13, wherein the oscillation sensitivity of the cured film/fiber made of the formulation of claim 13 at oscillation state should be at least 2 times that at static state.

18. An anti-impact cloth comprises:
a fabric base; and
one or more anti-impact films made from the formulation of claim 13 applied to at least one surface of the fabric base, with thickness no more than 3 mm, the impact resistance of the anti-impact film shall be at least level 1 according to such as ANSI 138 standard (transmitted force no more than 9 kN under impact energy of 5 J);
wherein the oscillation sensitivity the anti-impact film at oscillation state should be at least 2 times that at static state.

19. The anti-impact cloth of claim 18, wherein the density of the anti-impact film is less than 0.6 g/cm³ while the formulation contains expandable microspheres in sufficient amount.

20. A printable and extrudable energy absorption materials formulation comprising: (a) 100 parts of silicone rubber; (b) 35-45 parts per hundred rubber of PBDMS; (c) 2-10 parts per hundred rubber of hydroxyl functionalized filler; (d) 0.5-5 parts per hundred rubber of curing agent; (e) 2-5 parts per hundred rubber of sacrificial agent; (f) 0.2-1 parts per hundred rubber of a plasticizer; (g) 0.8-8 parts per hundred rubber of a dispersant; and (h) 1.2-8 parts per hundred rubber of reinforcing agent.
